(19) United States
(12) Patent Application Publication
(10) Pub. No.: US 2020/0068255 A1
(43) Pub. Date: Feb. 27, 2020

(54) Aggregation Of Multiple Media Types Of User Consumption Habits and Device Preferences

(71) Applicant: Intel Corporation, Santa Clara, CA (US)

(72) Inventors: Brian David Johnson, Portland, OR (US); Marcelino Ford-Livene, Pomona, CA (US); Brendan Traw, Portland, OR (US)

(21) Appl. No.: 16/666,038

(22) Filed: Oct. 28, 2019

Related U.S. Application Data
(63) Continuation of application No. 15/199,083, filed on Jun. 30, 2016, now abandoned.
Application No. 15/199,083 is a continuation of application No. 13/547,927, filed on Jul. 12, 2012, now abandoned.
Application No. 13/547,927 is a division of application No. 12/142,989, filed on Jun. 20, 2008, now abandoned.

(51) Int. Cl. H04N 21/442; H04N 21/61; H04N 21/466; H04N 21/4627; H04N 21/422; H04N 21/41; H04N 21/436; H04N 21/431; H04N 7/16; H04N 21/426

(52) U.S. Cl. CPC H04N 21/44222; H04N 21/6193; H04N 21/6168; H04N 21/4667; H04N 21/4627; H04N 21/44231; H04N 21/4126; H04N 21/43615; H04N 21/4316; H04N 7/163; H04N 21/42692; H04N 21/42203

(57) ABSTRACT

A system and method for the aggregation of multiple media types of user consumption habits and device preferences are described. In embodiments, a connected device is adapted to receive multiple inputs supporting different types of media, aggregating the multiple media types and displaying one or more of the media types on a single display device. Another embodiment of the invention provides for a way of collecting data about user-specific adjustments to or usages of the various electronic devices and/or applications connected to the connected device. Other embodiments are described and claimed.

### BACKGROUND

Today's homes may have one or more electronic devices that receive, process and/or store content, such as personal computers (PCs), televisions, digital video disk (DVD) players, video cassette recorder (VCR) players, compact disk (CD) players, set-top boxes (STBs), stereo receivers, audio/video receivers (AVRs), media centers, personal video recorders (PVRs), gaming devices, digital camcorders, digital cameras, blackberries, cellular phones, personal digital assistants (PDAs), and so forth. These all may be networked together in such a way to provide a user with a means for entertainment via a connected device and a single display device.

The aggregation of multiple media types of user consumption via the connected device opens up a new landscape of consumption habits for consumers. Often there is a necessity of advertising and other business models to help pay for the content and experiences consumers have become accustomed to on television, for example. While content service providers, device manufacturers, advertisers, and so forth, could benefit from the knowledge of the user consumption habits, user privacy remains a concern.

As mentioned above, many of today's homes have multiple electronic devices networked together to provide a means of entertainment via the connected device and single display device. It is typical for the different members of a family to share the multiple networked devices. Here, user preferences involving device specific settings are constantly being adjusted by the different members of the family.

### BRIEF DESCRIPTION OF THE DRAWINGS

FIG. 1 illustrates one embodiment of a system.

FIG. 2 illustrates one embodiment of a user interface.

FIG. 3 illustrates one embodiment of a logic flow.

FIG. 4 illustrates one embodiment of a logic flow.

FIG. 5 illustrates one embodiment of a system.

FIG. 6 illustrates one embodiment of a device.

### DETAILED DESCRIPTION

Various embodiments of the invention may be generally directed to the aggregation of multiple media types of user consumption habits and device preferences. In embodiments, a connected device is adapted to receive multiple inputs supporting different types of media, aggregating the multiple media types and displaying one or more of the media types on a single display device. The multiple inputs may represent various types of connections including wired, wireless, or a combination of both. More specifically, the multiple inputs may represent Internet Protocol (IP) input connections, person-to-person (P2P) input connections, cable/satellite/broadcast input connections, inputs from various electronic devices (e.g., televisions, DVD players, VCR players, CD or music players, STBs, stereo receivers, AVRs, media centers, PVRs, gaming devices, digital camcorders, digital cameras, blackberries, cellular phones, PDAs, laptops, flash devices, etc.), applications being processed by various electronic devices, and so forth.

An embodiment of the invention provides for the aggregation of multiple media types of user consumption via a connected device. Here, user media consumption habits are monitored by the connected device and stored as a media consumption report. The media consumption report may then be securely stored in a secured storage to ensure the privacy of individual users. Content service providers, device manufacturers, advertisers, and so forth, which could benefit from the knowledge of user consumption habits, may now have access to this information to better products and services provided to the consumer.

Another embodiment of the invention provides for a way of collecting data about user-specific adjustments to the various electronic devices and/or applications connected to the connected device. In embodiments, the collection of data is both anonymous and secure. The various electronic devices and/or applications may include electronic program guide (EPG) usage; device level controls (e.g., volume, channel favorites, display settings, etc.); device or client side specific program usage (e.g., DVD, CD, flash memory, etc.); IP, Coax or broadband delivered applications and services (social networking technology, VOD, recommendations, searches, etc.); information coming from devices via HDMI-CEC or any network; and so forth. Embodiments may use the user-specific adjustment data to automatically make adjustments to one or more devices connected to the connected device. Here, user-specific adjustments to the volume of the television when it is powered on or activated by the user may be accomplished via a user preference engine, for example. In embodiments, the user preference engine may use the collected adjustment data to monitor the behaviors of a specific user and to optimize consumer information and entertainment recommendations/searches.

A further embodiment of the invention provides for a user interface that includes one or more input-specific windows or sections that are overlayed on the main content section. The input-specific windows may represent data that is currently being processed by one or more of the electronic devices and/or applications connected to the connected device. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

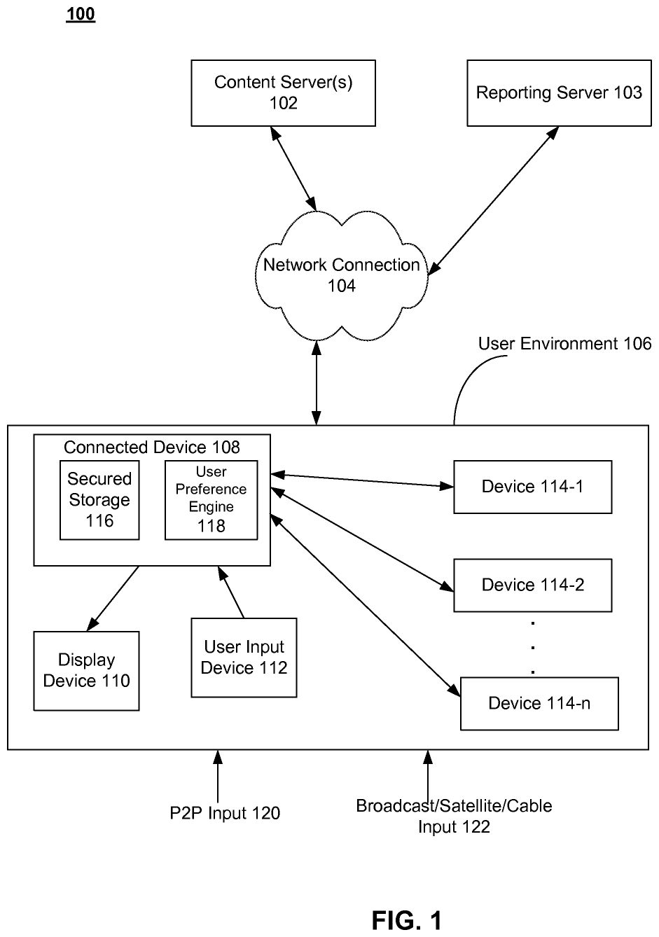

FIG. 1 illustrates an embodiment of a system 100. Referring to FIG. 1, system 100 may comprise content server(s) 102, a reporting server 103, a network connection 104 and a user environment 106. User environment 106 may include a connected device 108, a display device 110, a user input device 112 and devices 114 (114-1 through 114-n, where n is any positive integer). Connected device 108 may include a secured storage 116 and a user preference engine 118. A P2P input 120 and broadcast/satellite/cable inputs 122 are connected to device 108. Each of these elements is described next in more detail.

At a high level and in various embodiments, a content service provider (e.g., a television service provider) may host content server(s) 102 and reporting server 103. Content server 102 may store, but is not limited to, information about each of it users or subscribers and available content for each of its subscribers to download on demand. In such an embodiment, the distribution of the content is controlled because the content service provider hosts the content server where subscriber information is stored, the content service provider knows which content is included in a particular subscription with the content service provider and knows of subscriber-defined controls (e.g., parental controls) set up by the subscriber. Therefore, the content service provider, prior to allowing requested content to be distributed to the subscriber, can determine whether the subscriber has access rights to the requested content and whether the subscriber-defined controls allow for the content to be viewed.

In embodiments, reporting server 103 may be used to securely store the media consumer reports for subscribers of the content service provider. Reporting server 103 may also be used to track the consumption of advertising content inserted in the consumption data. This may facilitate in the appropriate billing of an advertising company, for example, when it is determined that the inserted advertising content was likely to have been viewed or consumed by a subscriber. Note that although the functionality of servers 102 and 103 is described herein as being separated into two components, this is not meant to limit the invention. In fact, this functionality may be combined into one component or separated into three or more components.

Servers 102 and 203 may communicate with user environment 106 (as well as other user environments not shown in FIG. 1) via network connection 104. Network connection 104 may be a high speed Internet connection or any other type of connection suited for the particular application. Other types of connections may be added or substituted as new connections are developed.

When an individual becomes a subscriber of a content service provider (or any company, including but not limited to, a telecommunications company or cable company, for example), the individual generally provides identifying or personal information to the content service provider for billing purposes and so forth. Yet, embodiments of the invention allow the personal identity of the subscriber to remain anonymous within system 100. For example, in embodiments, elements or components in system 100 each have a unique internet protocol (IP) address and use this IP address to identify and communicate with each other via network connection 104. Generally, the linkage of an IP address to the subscriber's personal information (e.g., name, home address, etc.) is not publicly available information. Thus, through the use of IP addresses in system 100 to communicate, embodiments of the invention may maintain an anonymous nature. For example, subscribers of the content service provider may be identified in system 100 only via a unique IP address. Subscriber profiles stored in content server 102 and/or reporting server 103 may be identified by the unique IP address. Thus, when a media consumption report is generated and forwarded to reporting server 103, it may all be accomplished anonymously. Accordingly, in embodiments, information relating to the subscriber's profile and consumed content is used anonymously in system 100.

In embodiments, user environment 106 may include a connected device 108. Connected device 108 may be owned, borrowed or licensed by its respective user. Connected device 108 is connected to network connection 104 and may communicate with servers 102 and 103 via its unique IP address, for example. As described above, connected device 108 may be identified by servers 102 and 103 via its unique IP address (and not by personal information of any user or subscriber).

In embodiments, connected device 108 is adapted to receive multiple inputs supporting different types of media, aggregating the multiple media types and displaying one or more of the media types on a single display device (e.g., display device 110). The multiple inputs may represent various types of connections including wired, wireless, or a combination of both. More specifically, the multiple inputs may represent Internet Protocol (IP) input connections (e.g., network connection 104), a person-to-person (P2P) input connection 120, broadcast/satellite/cable input connections 122 and inputs from various electronic devices 114. Example electronic devices may include, but are not limited to, televisions, DVD players, VCR players, CD or music players, STBs, stereo receivers, AVRs, media centers, PVRs, gaming devices, digital camcorders, digital cameras, blackberries, cellular phones, PDAs, laptops, flash devices, and so forth.

In embodiments, connected device 108 may represent a device that includes personal video recorder (PVR) functionality. PVR functionality records television data (i.e., requested content) in digital format (e.g., MPEG-1 or MPEG-2 formats) and stores the data in a hard drive or on a server, for example. The data may also be stored in a distributed manner such as on one or more connected devices throughout a home or office environment.

An embodiment of the invention provides for the aggregation of multiple media types of user consumption via connected device 108. Here, user media consumption habits via the multiple inputs are collected by connected device 108 and saved as a media consumption report. The media consumption report may then be securely stored in secured storage 116 to ensure the privacy of individual users. In embodiments, the media consumption reports may be encrypted prior to being stored in secured storage 116. In embodiments, the media consumption reports may be stored in the hard disk drive (HDD) or in flash memory. The media consumption reports may also be stored at reporting server 103. As described above, content service providers, device manufacturers, advertisers, and so forth, may access the media consumption reports to better products and services provided to the consumer.

In embodiments, the multiple media content may be any type of content or data. Examples of media content may generally include any data or signals representing information meant for a user, such as voice information, video information, audio information, image information, textual information, numerical information, alphanumeric symbols, graphics, and so forth. The embodiments are not limited in this context.

As mentioned above, many of today's homes have multiple electronic devices networked together to provide a means of entertainment via a connected device (such as connected device 108) and a single display device (such as display device 110). It is typical for the different members of a family to share the multiple networked devices. Here, user preferences involving device specific settings are constantly being adjusted by the different members of the family. An embodiment of the invention provides for a way of collecting data about user-specific adjustments to the various electronic devices 114 and/or applications connected to connected device 108. The user-specific adjustment data may be used by user preference engine 118 to automatically make adjustments to one or more devices connected to connected device 108. The various user-specific adjustments may include electronic program guide (EPG) usage; device level controls (e.g., volume, channel favorites, display settings, etc.); device or client side specific program or application usage (e.g., DVD, CD, flash memory, etc.); IP, Coax or broadband delivered applications and services (social networking technology, VOD, recommendations, searches, etc.); information coming from devices via HDMI-CEC or any network; and so forth.

In embodiments, a specific user is identified by connected device 108 or user preference engine 118. The user may identify himself or herself to connected device 108 via a typical login and password combination. The user may also be identified by connected device 108 via various biometric data devices, including but not limited to, fingerprint scan devices, retina scan devices, voice identification devices, and so forth.

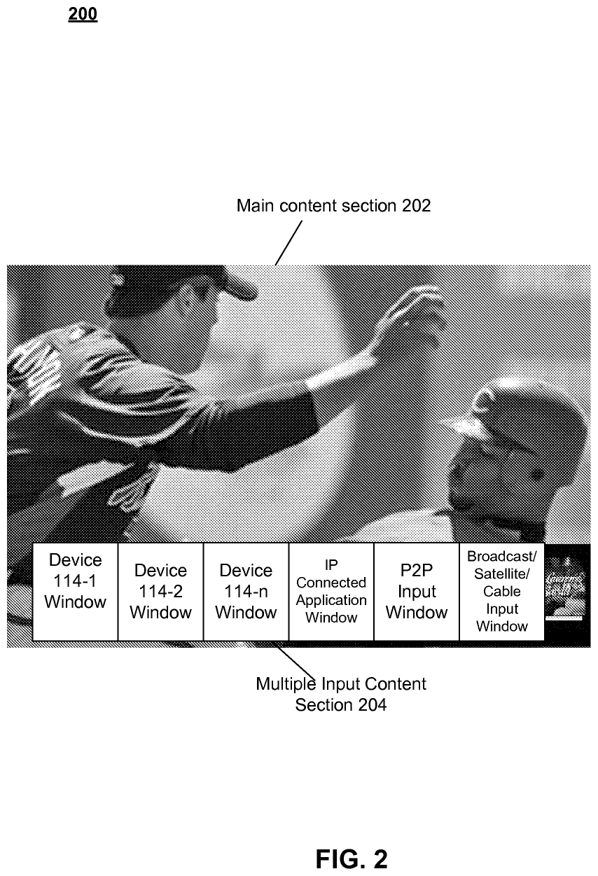

Once a specific user is identified, connected device 108 may collect user-specific adjustment data to one or more of the various electronic devices 114 and/or applications connected to connected device 108. The adjustment data may be stored in user preference engine 118, for example. In embodiments, engine 118 stores the adjustment data in a secure and anonymous manner. The adjustment data may be provided to connected device 108 by devices 114 and/or applications. A user interface (such as the one described below with reference to FIG. 2) may be accessed by the user to make adjustments to electronic devices 114 and/or applications via connected device 108.

Once adjustment data is collected for an identified user, user preference engine 118 may use the data to automatically make applicable adjustments to one or more devices 114 and/or applications to suit the identified user's preferences. For example, assume that device 114-1 is a television and the identified user always turns the volume to level 6 in the morning hours and up to level 9 in the evening hours. Here, user preference engine 118 may collect that information and store it in user preference engine 118. The next time the television is powered on or activated by the identified user, user preference engine 118 may automatically adjust the volume of the television to level 6 or 9 depending on the time of day. In embodiments, user preference engine 118 may use the collected user-specific adjustment data to monitor the behaviors of a specific user and to optimize consumer information and entertainment recommendations/searches. These examples are provided for illustrations purposes only and are not meant to limit the invention.

Referring back to FIG. 1, user environment 106 may also include display device 110 and user input device 112. Display device 110 may be a monitor, projector, a conventional analog television receiver, or any other kind of perceivable video display. The audio portion of the output of the connected devices may be routed through an amplifier, such as an audio/video (A/V) receiver or a sound processing engine, to headphones, speakers or any other type of sound generation device. User input device 112 may be any type of input device suited for a user to communicate with connected device 108.

In various embodiments, system 100 may be implemented as a wireless system, a wired system, or a combination of both. When implemented as a wireless system, system 100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

A further embodiment of the invention provides for a user interface that includes one or more input-specific windows or sections that are overlayed on a main content section. The input-specific windows may represent data that is currently being processed by one or more of the electronic devices and/or applications connected to connected device 108.

Referring to FIG. 2, one embodiment of a user interface 200 is shown. User interface 200 may comprise a main content section 202 and a multiple input content section 204. In an embodiment, multiple input content section 204 is divided into multiple windows, where each window may represent data that is currently being processed by one of electronic devices 114 and/or applications connected to device 108 (e.g., P2P input 120, broadcast/satellite/cable inputs 122, and so forth).

User interface 200 may be displayed on display device 110, for example. Although multiple input content section 204 is illustrated as having six sections or windows, this is not meant to limit the invention. Section 204 may include any number of windows. Each of these sections is described next in more detail.

In embodiments, main content section 202 displays the primary content that is being watched by a user. The main content may be broadcasted, received via cable or satellite feeds, pre-recorded and stored on a digital recording device (such as a personal video recorder (PVR)), streamed or downloaded via the Internet via an IP connection, stored on a home local area network (LAN), received via various types of video interconnects (e.g., Video Graphics Array (VGA), High-Definition Multimedia Interface (HDMI), component video, composite video, etc.), and so forth. In embodiments, the content being displayed in section 202 cannot be altered by the user. The content displayed in section 202 may include shows or programs, graphics, video games, books, video shorts, video previews, news clips, news highlights, and so forth. Related voice, audio, music, etc., may also be presented with the displayed content in section 202.

In embodiments, content displayed in multiple input content section 204 may be dynamic in the sense that the first window might display the content being processed by device 114-1 at a given time and display the content being processed by device 114-3 at another time, for example. In embodiments, content displayed in any window of section 204 may be any content or information or graphics (e.g., audio, video or graphics signal) that is overlayed or blended with another content or information or graphics (e.g., audio, video or graphics signal). In embodiments, the content may be streamed or downloaded to connected device 108 from the Internet via an IP connection (for example, via content server 102 and network connection 104 from FIG. 1), via a P2P connection (such as input 120), via broadcast/satellite/cable (such as input 122), and so forth. In other embodiments, the content may be content received via any USB device connection (such as from devices 114). This contact may be content that is dynamic or constantly updated via an IP delivered site, system or service or via a USB device, for example. User interface 200 may be displayed on a display device (such as display device 110). A television may be an example display device.

Referring again to FIG. 2, user interface 200 illustrates one display format where section 204 is smaller in size than main content section 202 and positioned on the lower area of user interface 200. Embodiments of the invention are not limited to the display format illustrated in FIG. 2. In fact, embodiments of the invention allow the user to customize the content displayed in section 204 and to customize the position and size of section 204 in user interface 200. Here, the user may download a program element to a connected device (such as connected device 108 from FIG. 1) from an IP delivered site or service or from a USB device (for example) that allows the user to customize section 204 to reflect user preferences. The customization of section 204 may include the number of windows, the content displayed in each of the windows, and the size and location of section 204 on user interface 200. In embodiments, the user may elect to watch what is being displayed in one of the windows of section 204. Here, the window may be expanded to include all of user interface 200.

In embodiments, the user may use connected device 108 to overlay or blend the multiple input content with main content on the single display device without altering the main content. In embodiments, the main content may be decoded and then re-encoded with the multiple input content. In embodiments, the overlay or blending of the multiple input content and main content may be a hardware-enabled overlay or blend via a microprocessor, chipset, graphics card, etc. In other embodiments, the overlay or blending of the multiple input content and main content may be a software-enabled overlay or blend via a specific application, operating system, etc. In yet other embodiments, the overlay or blending may be via a combination of hardware and/or software components. In addition, there may be some overlay or blending in the pipes themselves or via another method while the content is in route to the screen. This may be implemented with wireless connection technology, wired connection technology, or a combination of both. The user may customize or configure user interface 200 directly on connected device 108 or via a user input device such as a remote control or PC, for example.

As stated above, a user interface (such as user interface 200) may be accessed by the user to make adjustments to electronic devices 114 and/or applications via connected device 108. Here, for example, a volume bar may be displayed in the window for device 114-1. The user may adjust the volume of device 114-1 indirectly by adjusting the volume bar in the window. The volume adjustment is processed by connected device 108 and sent to device 114-1, where the volume of device 114-1 is adjusted accordingly. The types of adjustments to devices 114 and/or applications via connected device 108 may include all adjustments provided by the devices themselves.

Operations for the embodiments described herein may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments, however, are not limited to the elements or in the context shown or described in the figures.

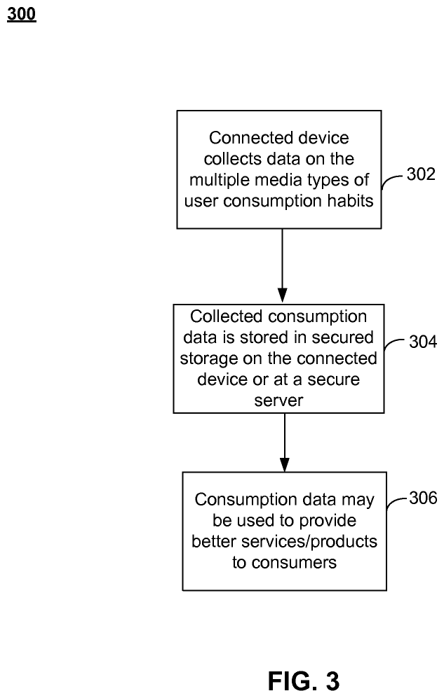

FIG. 3 illustrates one embodiment of a logic flow 300. As shown in logic flow 300, a connected device (such as connected device 108 from FIG. 1) collects data on user consumption habits of multiple media types (block 302). The collected consumption data is stored in a secured storage (such as secured storage 116 of FIG. 1) or at a secure server (such as reporting server 103 of FIG. 1) (block 304). The consumption data may be used to provide better services and/or products to consumers (block 306).

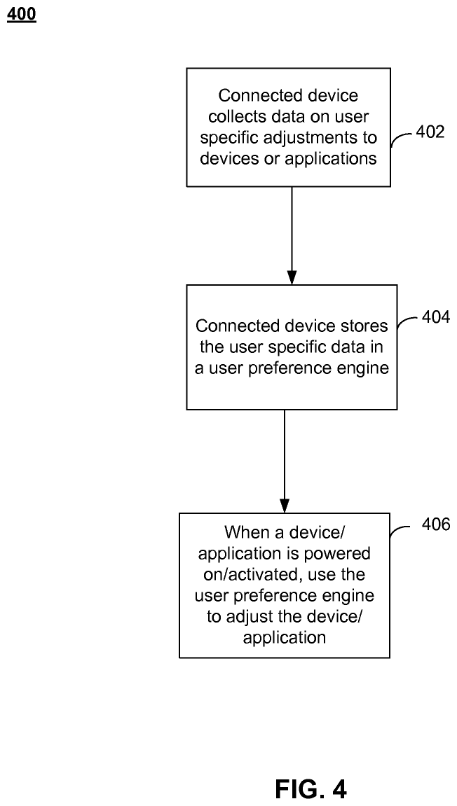

FIG. 4 illustrates one embodiment of a logic flow 400. Referring to FIG. 4, the connected device collects data on user specific adjustments to devices or applications run on the devices (block 402). The connected device stores the adjustment data in a user preference engine (such as engine 118 of FIG. 1) (block 404). When a device/application is powered on or activated by the specific or identified user, the user preference engine is used to automatically make applicable adjustments to the device/application (block 406).

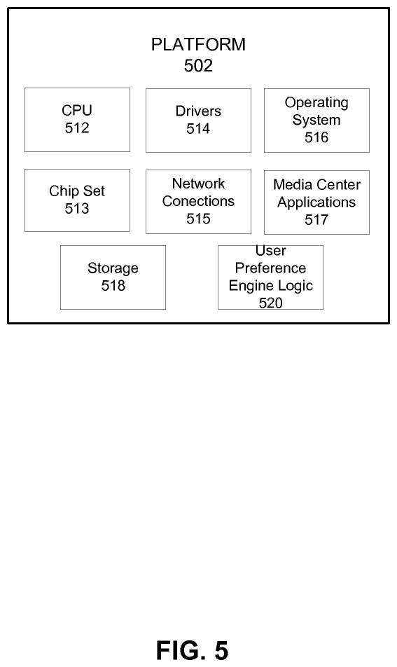

FIG. 5 illustrates an embodiment of a platform 502 (e.g., connected device 108 from FIG. 1). In one embodiment, platform 502 may comprise or may be implemented as a media platform 502 such as the Viiv™ media platform made by Intel® Corporation. In one embodiment, platform 502 may interact with the content servers and/or reporting server (such as servers 102 and 103 via network connection 104 from FIG. 1).

In one embodiment, platform 502 may comprise a CPU 512, a chip set 513, one or more drivers 514, one or more network connections 515, an operating system 516, and/or one or more media center applications 517 comprising one or more software applications, for example. Platform 502 also may comprise storage 518 and user preference engine logic 520.

In one embodiment, CPU 512 may comprise one or more processors such as dual-core processors. Examples of dual-core processors include the Pentium® D processor and the Pentium® processor Extreme Edition both made by Intel® Corporation, which may be referred to as the Intel Core Duo® processors, for example.

In one embodiment, chip set 513 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 514 may comprise the Quick Resume Technology Drivers made by Intel® to enable users to instantly turn on and off platform 502 like a television with the touch of a button after initial boot-up, when enabled, for example. In addition, chip set 513 may comprise hardware and/or software support for 5.1 surround sound audio and/or high definition 7.1 surround sound audio, for example. Drivers 514 may include a graphics driver for integrated graphics platforms. In one embodiment, the graphics driver may comprise a peripheral component interconnect (PCI) Express graphics card.

In one embodiment, network connections 515 may comprise the PRO/1000 PM or PRO/100 VE/VM network connection, both made by Intel® Corporation.

In one embodiment, operating system 516 may comprise the Windows® XP Media Center made by Microsoft® Corporation. In other embodiments, operating system 516 may comprise Linux®, as well as other types of operating systems. In one embodiment, one or more media center applications 517 may comprise a media shell to enable users to interact with a remote control device from a distance of about 10-feet away from platform 502 or a display device, for example. In one embodiment, the media shell may be referred to as a “10-feet user interface,” for example. In addition, one or more media center applications 517 may comprise the Quick Resume Technology made by Intel®, which allows instant on/off functionality and may allow platform 502 to stream content to media adaptors when the platform is turned “off.”

In one embodiment, storage 518 may comprise the Matrix Storage technology made by Intel® to increase the storage performance enhanced protection for valuable digital media when multiple hard drives are included. In one embodiment, user preference engine logic 520 is used to enable the functionality of the invention as described herein. The embodiments, however, are not limited to the elements or in the context shown or described in FIG. 5.

Platform 510 may establish one or more logical or physical channels to communicate information. The information may include media information and control information. Media information may refer to any data representing content meant for a user. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

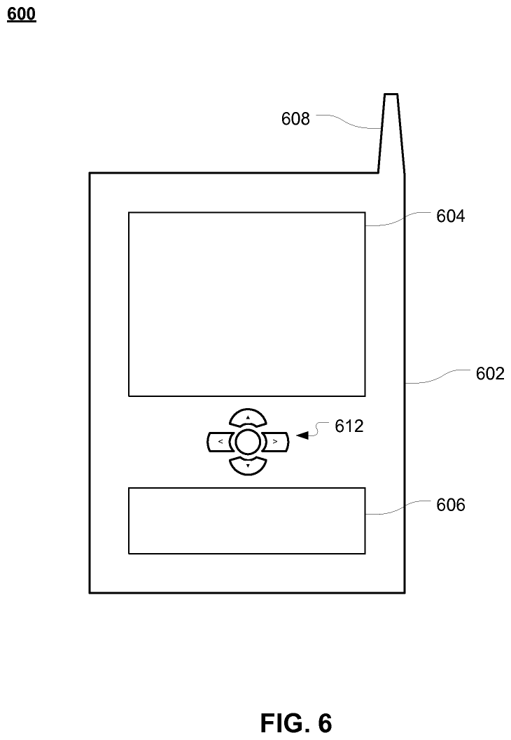

FIG. 6 illustrates one embodiment of a device 600 in which functionality of the present invention as described herein may be implemented. In one embodiment, for example, device 600 may comprise a communication system. In various embodiments, device 600 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, blackberry, and so forth. The embodiments are not limited in this context.

In one embodiment, device 600 may be implemented as part of a wired communication system, a wireless communication system, or a combination of both. In one embodiment, for example, device 600 may be implemented as a mobile computing device having wireless capabilities. A mobile computing device may refer to any device having a processing system and a mobile power source or supply, such as one or more batteries, for example.

Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise a five-way navigation button 612. I/O device 606 may comprise a suitable keyboard, a microphone, and/or a speaker, for example. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-21. (canceled)

22. A handheld mobile computing device for wireless communication, when the handheld mobile computing device is in operation, with at least one server via at least one Internet network, the handheld mobile computing device comprising:
at least one battery to supply power to the handheld mobile computing device;
an antenna for use in the wireless communication;
a microphone for use in providing, when the handheld mobile computing device is in the operation, voice data for use in voice recognition and voice communication;
wherein, when the handheld mobile computing device is in the operation:
the handheld mobile computing device is to identify a user of the handheld mobile computing device via biometric data;
the handheld mobile computing device is to receive user preference data via a user interface of the handheld mobile computing device;
based, at least in part, upon the user preference data, the handheld mobile computing device is configurable to automatically adjust at least one volume-related setting and at least one display-related setting based, at least in part, upon current time of day;
the handheld mobile computing device is configurable to receive media content data from the at least one server via the at least one Internet network;
the media content data is to be provided pursuant to a subscription associated with a media content subscription service;
the subscription is configurable to be associated with subscriber profile information and subscriber media content consumption information; and
the subscriber media content consumption information is to be stored, at least in part, both at the handheld mobile computing device and the at least one server.

23. The handheld mobile computing device of claim 22, wherein:
the biometric data comprises fingerprint scan data.

24. The handheld mobile computing device of claim 22, wherein:
the at least one display-related setting comprises display level control setting; and
the at least one volume-related setting comprises volume level control setting.

25. The handheld mobile computing device of claim 24, wherein:
when in the operation, the handheld mobile computing device is configurable to adjust automatically the display level control setting and the volume level control setting based, at least in part, upon the user preference data and whether the current time of day is in the evening.

26. The handheld mobile computing device of claim 25, wherein:
when in the operation, the handheld mobile computing device is configurable to adjust the display level control setting and the volume level control setting also based, at least in part, upon whether the current time of day is in the morning.

27. A handheld mobile computing device for wireless communication, when the handheld mobile computing device is in operation, with at least one server via at least one Internet network, the handheld mobile computing device comprising:
at least one battery to supply power to the handheld mobile computing device;
an antenna for use in the wireless communication;
a microphone for use in providing, when the handheld mobile computing device is in the operation, voice data for use in voice recognition and voice communication;
at least one multi-core central processing unit; and
machine-readable storage storing instructions for execution by the at least one multi-core central processing unit, the instructions, when executed by the at least one multi-core central processing unit resulting in the handheld mobile computing device being configured for performance of operations comprising:
identifying a user of the handheld mobile computing device via biometric data;
receiving user preference data via a user interface of the handheld mobile computing device;
based, at least in part, upon the user preference data, automatically adjusting at least one volume-related setting and at least one display-related setting based, at least in part, upon current time of day; and
receiving media content data from the at least one server via the at least one Internet network; and
wherein:
the media content data is to be provided pursuant to a subscription associated with a media content subscription service;
the subscription is configurable to be associated with subscriber profile information and subscriber media content consumption information; and
the subscriber media content consumption information is to be stored, at least in part, both at the handheld mobile computing device and the at least one server.

28. The handheld mobile computing device of claim 27, wherein:
the biometric data comprises fingerprint scan data.

29. The handheld mobile computing device of claim 27, wherein:
the at least one display-related setting comprises display level control setting; and
the at least one volume-related setting comprises volume level control setting.

30. The handheld mobile computing device of claim 29, wherein the operations also comprise:
adjusting automatically the display level control setting and the volume level control setting based, at least in part, upon the user preference data and whether the current time of day is in the evening.

31. The handheld mobile computing device of claim 30, wherein:
the adjusting automatically of the display level control setting and the volume level control setting is also based, at least in part, upon whether the current time of day is in the morning.

32. At least one non-transitory machine-readable medium storing instructions for execution by a handheld mobile computing device, the handheld mobile computing device being for wirelessly communicating, when the handheld mobile computing device is in operation, with at least one server, the instructions, when executed by the handheld mobile computing device, resulting in the handheld mobile computing device being configured for performance of operations comprising:
identifying a user of the handheld mobile computing device via biometric data;
receiving user preference data via a user interface of the handheld mobile computing device;
based, at least in part, upon the user preference data, automatically adjusting at least one volume-related setting and at least one display-related setting based, at least in part, upon current time of day; and
receiving media content data from the at least one server via the at least one Internet network; and
wherein:
the media content data is to be provided pursuant to a subscription associated with a media content subscription service;
the subscription is configurable to be associated with subscriber profile information and subscriber media content consumption information; and
the subscriber media content consumption information is to be stored, at least in part, both at the handheld mobile computing device and the at least one server.

33. The at least one non-transitory machine-readable medium of claim 32, wherein:
the biometric data comprises fingerprint scan data.

34. The at least one non-transitory machine-readable medium of claim 32, wherein:
the at least one display-related setting comprises display level control setting; and
the at least one volume-related setting comprises volume level control setting.

35. The at least one non-transitory machine-readable medium of claim 34, wherein the operations also comprise:
adjusting automatically the display level control setting and the volume level control setting based, at least in part, upon the user preference data and whether the current time of day is in the evening.

36. The at least one non-transitory machine-readable medium of claim 35, wherein:
the adjusting automatically of the display level control setting and the volume level control setting is also based, at least in part, upon whether the current time of day is in the morning.

37. A handheld mobile computing device for wireless communication, when the handheld mobile computing device is in operation, with at least one server via at least one Internet network, the handheld mobile computing device comprising:
power supply means for supplying power to the handheld mobile computing device;
an antenna for use in the wireless communication;
a microphone for use in providing, when the handheld mobile computing device is in the operation, voice data for use in voice recognition and voice communication;
processing means; and
storage means storing instructions for execution by the processing means, the instructions, when executed by the processing means resulting in the handheld mobile computing device being configured for performance of operations comprising:
identifying a user of the handheld mobile computing device via biometric data;
receiving user preference data via a user interface of the handheld mobile computing device;
based, at least in part, upon the user preference data, automatically adjusting at least one volume-related setting and at least one display-related setting based, at least in part, upon current time of day; and
receiving media content data from the at least one server via the at least one Internet network; and
wherein:
the media content data is to be provided pursuant to a subscription associated with a media content subscription service;
the subscription is configurable to be associated with subscriber profile information and subscriber media content consumption information; and
the subscriber media content consumption information is to be stored, at least in part, both at the handheld mobile computing device and the at least one server.

38. The handheld mobile computing device of claim 37, wherein:
the biometric data comprises fingerprint scan data.

39. The handheld mobile computing device of claim 37, wherein:
the at least one display-related setting comprises display level control setting; and
the at least one volume-related setting comprises volume level control setting.

40. The handheld mobile computing device of claim 39, wherein the operations also comprise:
adjusting automatically the display level control setting and the volume level control setting based, at least in part, upon the user preference data and whether the current time of day is in the evening.

41. The handheld mobile computing device of claim 40, wherein:
the adjusting automatically of the display level control setting and the volume level control setting is also based, at least in part, upon whether the current time of day is in the morning.
